(19) United States
(12) Patent Application Publication
(10) Pub. No.: US 2025/0218098 A1
(43) Pub. Date: Jul. 3, 2025

(54) TRANSMISSION SYSTEM, TRANSMISSION METHOD, AND NON-TRANSITORY STORAGE MEDIUM

(71) Applicant: JVCKENWOOD Corporation, Yokohama-shi (JP)

(72) Inventors: Takayuki Sugahara, Yokohama-shi (JP); Isao Hijikata, Yokohama-shi (JP); Kazunari Nishioka, Yokohama-shi (JP)

(21) Appl. No.: 19/079,530

(22) Filed: Mar. 14, 2025

Related U.S. Application Data
(63) Continuation of application No. PCT/JP2023/033153, filed on Sep. 12, 2023.

(30) Foreign Application Priority Data
Sep. 15, 2022 (JP) 2022-147285

(51) Int. Cl. G06T 13/40; H04L 65/1066; H04L 67/104

(52) U.S. Cl. CPC G06T 13/40; H04L 65/1066; H04L 67/1044

(57) ABSTRACT

A transmission system includes: terminal devices each configured to transmit primary information including an image and/or audio of a user in a real space and secondary information including an image and/or audio of the user in a virtual space in association with a time; and a server device configured to: acquire the primary and the secondary information from the terminal devices; set avatar information regarding the image and the audio of avatars of the users in the virtual space based on the secondary information and transmit the avatar information to the terminal devices; determine whether the avatars are in an intercommunication state based on an arrangement state of the avatars in the virtual space; and switch the avatar information of the avatars in the intercommunication state to avatar information based on the primary information and transmit the avatar information to the terminal devices for the avatars in the intercommunication state.

### CROSS-REFERENCE TO RELATED APPLICATIONS

This application is a Continuation of PCT International Application No. PCT/JP2023/033153 filed on Sep. 12, 2023 which claims the benefit of priority from Japanese Patent Application No. 2022-147285 filed on Sep. 15, 2022, the entire contents of both of which are incorporated herein by reference.

### FIELD OF THE INVENTION

The present application relates to a transmission system, a transmission method, and a non-transitory storage medium.

### BACKGROUND OF THE INVENTION

There is a known technology that enables, in a virtual space, communication between multiple users via individual avatars. For example, Japanese Patent Application Laid-open No. H11-289524 discloses a technology in which participants in a video conference perform intercommunication by sharing a scene in which avatars appearing on a television screen are talking to each other.

In the technology disclosed in Japanese Patent Application Laid-open No. H11-289524, in which avatars are set in a virtual space to facilitate communication, it is required to implement realistic communication.

### SUMMARY OF THE INVENTION

A transmission system, a transmission method, and a non-transitory storage medium are disclosed.

According to one aspect of the present application, there is provided a transmission system comprising: multiple terminal devices each of which is configured to transmit primary information and secondary information in association with a time, the primary information including at least one of an image or audio of a user in a real space, the secondary information including at least one of an image or audio of the user in a virtual space; and a server device configured to: acquire the primary information and the secondary information transmitted from each of the terminal devices; set avatar information regarding the image and the audio of each of avatars of the users in the virtual space based on the secondary information and transmit the avatar information to each of the terminal devices; determine whether or not the avatars are in an intercommunication state based on an arrangement state of the avatars in the virtual space; and switch the avatar information of the avatars determined to be in the intercommunication state to the avatar information based on the primary information and transmit the switched avatar information to the terminal devices corresponding to the avatars determined to be in the intercommunication state.

According to one aspect of the present application, there is provided a transmission method for a transmission system that comprises multiple terminal devices and a server device, the method comprising: transmitting, by each of the multiple terminal devices, primary information and secondary information in association with a time, the primary information including at least one of an image or audio of a user in a real space, the secondary information including at least one of an image or audio of the user in a virtual space; and acquiring, by the server device, the primary information and the secondary information transmitted from each of the terminal devices, setting avatar information regarding the image and the audio of each of avatars of the users in the virtual space based on the secondary information and transmitting the avatar information to each of the terminal devices, determining whether or not the avatars are in an intercommunication state based on an arrangement state of the avatars in the virtual space, and switching the avatar information of the avatars determined to be in the intercommunication state to the avatar information based on the primary information and transmitting the switched avatar information to the terminal devices corresponding to the avatars determined to be in the intercommunication state.

According to one aspect of the present application, there is provided a non-transitory storage medium that stores a transmission program for a transmission system that comprises multiple terminal devices and a server device, the program causing a computer to execute: transmitting, by each of the multiple terminal devices, primary information and secondary information in association with a time, the primary information including at least one of an image or audio of a user in a real space, the secondary information including at least one of an image or audio of the user in a virtual space; and acquiring, by the server device, the primary information and the secondary information transmitted from each of the terminal devices, setting avatar information regarding the image and the audio of each of avatars of the users in the virtual space based on the secondary information and transmitting the avatar information to each of the terminal devices, determining whether or not the avatars are in an intercommunication state based on an arrangement state of the avatars in the virtual space, and switching the avatar information of the avatars determined to be in the intercommunication state to the avatar information based on the primary information and transmitting the switched avatar information to the terminal devices corresponding to the avatars determined to be in the intercommunication state.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a schematic diagram illustrating an example of a transmission system according to the present embodiment;

FIG. 2 is a functional block diagram illustrating an example of a transmission system according to the present embodiment;

FIG. 3 is a functional block diagram illustrating an example of a hardware configuration of an information processing device according to the present embodiment;

FIG. 4 is a diagram illustrating an example of an arrangement state of avatars in a virtual space;

FIG. 5 is a diagram illustrating an example of an arrangement state of avatars in a virtual space;

FIG. 6 is a diagram illustrating an example of an arrangement state of avatars in a virtual space;

FIG. 7 is a diagram illustrating an example of information displayed on a display of a terminal device;

FIG. 8 is a diagram illustrating an example of information displayed on a display of a terminal device;

FIG. 9 is a diagram illustrating another example of information displayed on a display of a terminal device;

FIG. 10 is a diagram illustrating another example of information displayed on a display of a terminal device; and

FIG. 11 is a flowchart illustrating an example of a processing flow in a transmission system according to the present embodiment.

### DETAILED DESCRIPTION OF THE PREFERRED EMBODIMENTS

Hereinafter, embodiments of a transmission system, a transmission method, and a non-transitory storage medium according to the present application will be described with reference to drawings. Note that the present invention is not limited to the embodiments. Furthermore, the components in the following embodiments include components that are replaceable by and easy for those skilled in the art, or components that are substantially identical.

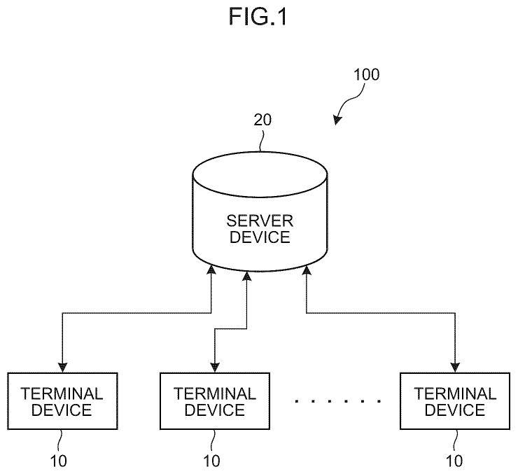

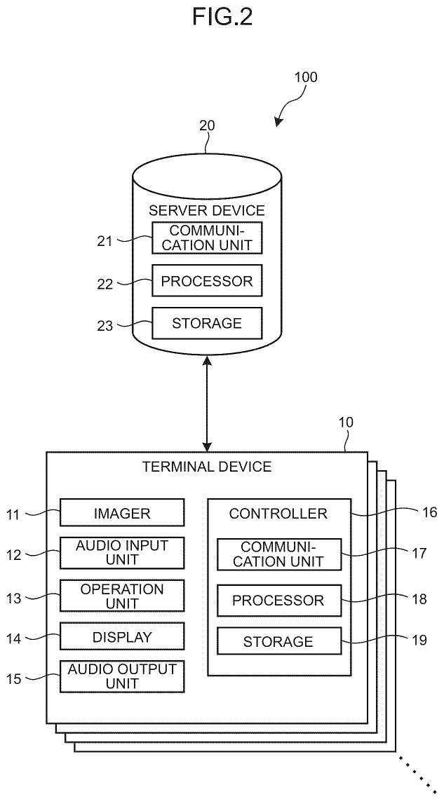

FIG. 1 is a schematic diagram illustrating an example of a transmission system 100 according to the present embodiment. FIG. 2 is a functional block diagram illustrating an example of the transmission system 100 according to the present embodiment. As illustrated in FIG. 1 and FIG. 2, the transmission system 100 according to the present embodiment includes multiple terminal devices 10 and a server device 20. The transmission system 100 illustrated in FIG. 1 and FIG. 2 is a system that uses a virtual space provided by the server device 20 when each of the terminal devices 10 accesses the server device 20 via a network. Examples of the virtual space include various virtual spaces that correspond to real spaces such as an office, a conference room for a web conference, a store, a shopping mall, and the like.

Examples of the terminal device 10 include information terminals such as a laptop personal computer, a desktop personal computer, a tablet, and a smartphone. Each terminal device 10 includes an imager 11, an audio input unit 12, an operation unit 13, a display 14, an audio output unit 15, and a controller 16.

The imager 11 images a user of the terminal device 10 and generates imaging information. The imager 11 outputs the generated imaging information to the controller 16. The imager 11 includes an imaging device such as a visible light camera, a far-infrared camera, or a near-infrared camera. The imager 11 may include, for example, a combination of the visible light camera, the far-infrared camera, and the near-infrared camera.

The audio input unit 12 captures sound, such as a user's voice of the terminal device 10 and ambient sounds around the terminal device 10, and generates audio collecting information. The audio input unit 12 transmits the generated audio collecting information to the controller 16. The audio input unit 12 includes an audio collecting device such as a microphone.

The operation unit 13 receives various operations performed by the user of the terminal device 10 and outputs the operations signals to the controller 16. As the operation unit 13, for example, an input device such as a mouse, a keyboard, a touch panel, a button, a lever, a dial, or a switch is used.

The display 14 displays various types of information. Examples of the display 14 include a liquid crystal display and an organic electro-luminescence (EL) display. The display 14 may be, for example, a head-mounted display that is worn on a user's head. The display 14 displays an image based on an image signal output from the controller 16.

The audio output unit 15 is a device that outputs various pieces of the audio collecting information. The audio output unit 15 may be a speaker that is externally connected to the controller 16, or may be a speaker that is built into a housing that accommodates the controller 16. The audio output unit 15 outputs audio based on the audio signal output from the controller 16.

The controller 16 comprehensively controls the operation of the terminal device 10. The controller 16 includes a communication unit 17, a processor 18, and a storage 19.

The communication unit 17 performs wired or wireless communication with an external device. The communication unit 17 performs communication with the server device 20. The communication unit 17 transmits primary information and secondary information of the user to the server device 20 under the control of the processor 18 described later. The communication unit 17 outputs spatial display information, audio output information, and avatar information in the virtual space received from the server device 20 to the processor 18. Note that the spatial display information is information for displaying an image in the virtual space on the display 14. The audio output information is information for outputting audio in the virtual space from the audio output unit 15. The avatar information includes information for displaying an avatar in the virtual space on the display 14 and information for outputting audio produced by the avatar from the audio output unit 15.

The processor 18 performs various types of processing. The processor 18 acquires the spatial display information, the audio output information, and the avatar information, which are received by the communication unit 17. Based on the acquired spatial display information, audio output information, and avatar information, the processor 18 causes the display 14 to display the image of the virtual space and the image of the avatar, and causes the audio output unit 15 to output the audio in the virtual space and the audio produced by the avatar.

The processor 18 generates primary information and secondary information of the user based on the imaging information from the imager 11, the audio collecting information from the audio input unit 12, the operation signal from the operation unit 13, and the like. Here, the primary information is information that includes at least one of the image or the audio in a real space of a user. Furthermore, the secondary information is information that includes at least one of the image or the audio in a virtual space of the user. The primary information and the secondary information are used when setting the above- described avatar information in the server device 20. The processor 18 controls the communication unit 17 to transmit the generated primary information and the generated secondary information to the server device 20 in association with a time.

For example, in a case where the user operates the operation unit 13 to control the avatars' action in the virtual space, the processor 18 generates operation information for the avatar in accordance with content of the operation. The processor 18 causes the communication unit 17 to transmit the generated operation information to the server device 20.

The storage 19 stores various types of information. The storage 19 stores computer programs, data, and the like for the processor 18 to perform various types of processing. In the terminal devices 10, the storage 19 stores a computer program that causes a computer to execute a step of transmitting the primary information and the secondary information in association with the time, the primary information including at least one of the image or the audio in the real space of the user, the secondary information including at least one of the image or the audio in the virtual space of the user.

The server device 20 includes a communication unit 21, a processor 22, and a storage 23.

The communication unit 21 performs wired or wireless information communication with the terminal devices 10.

The processor 22 performs various types of processing including processing for operating and managing the virtual space. In a case where there is an access to the terminal device 10 to use the virtual space, the processor 22 causes the communication unit 21 to transmit spatial display information and audio output information of the virtual space to the terminal device 10. Furthermore, the processor 22 acquires the primary information and the secondary information transmitted from each of the terminal devices 10 and received by the communication unit 21.

The processor 22 sets avatar information of the user in the virtual space based on at least one of the acquired primary information or the acquired secondary information, and causes the communication unit 21 to transmit the avatar information to the terminal device 10.

In this case, the processor 22 sets the avatar information based on the secondary information in an initial state and causes the communication unit 21 to transmit the avatar information to the terminal device 10. Furthermore, after setting the avatar information in the initial state, the processor 22 determines whether or not the avatars in the virtual space are in an intercommunication state, and switches the avatar information to the setting based on the primary information and transmits the avatar information to the terminal devices 10 in which the avatars is in the intercommunication state.

The processor 22 determines whether or not the avatars are in the intercommunication state based on an arrangement state of the avatars in the virtual space. For example, an avatar's position in the virtual space, a direction in which the avatar is facing in the virtual space, the avatar's posture in the virtual space, whether or not the avatar is acting, and the like are examples in the arrangement state. For example, the processor 22 can determine that the avatars are in the intercommunication state when a distance between the avatars in the virtual space is equal to or less than a predetermined value. Furthermore, the processor 22 can determine that the avatars facing each other in the virtual space are in the intercommunication state. Furthermore, in a case where one avatar talks to another avatar in the virtual space, the processor 22 can determine that one avatar and another avatar are in an intercommunication state.

The processor 22 switches the video and the audio of the avatars determined to be in the intercommunication state to the video and the audio of the avatars based on the primary information and transmits the switched image and the switched audio to the terminal devices 10 which correspond to the avatars determined to be in the intercommunication state. In other words, the images of the avatars are images based on the primary information for users who are trying to communicate with each other in the virtual space. On the other hand, the processor 22 transmits, to the terminal devices 10 which correspond to the avatars determined not to be in the intercommunication state, the images and the audio of the avatars determined not to be in the intercommunication state still based on the secondary information. In other words, the images and the audio of the avatars that are not in the intercommunication state in the virtual space are not switched. In this manner, by displaying the avatars who are in the intercommunication state as distinguished from other avatars, a realistic display can be implemented.

The processor 22 can determine a degree of the intercommunication state based on the arrangement state of the avatars that are determined to be in the intercommunication state. In this case, the processor 22 can set a reflection level of the primary information based on the degree of the intercommunication state. For example, the processor 22 can increase the reflection level of the primary information as the avatars get closer to each other. In this case, the processor 22 can increase the reflection level of the primary information in a stepwise manner, for example, by setting only one of the audio and an avatar outline based on the primary information, setting both the audio and the avatar outline based on the primary information, setting information regarding all the audio and the avatar based on the primary information, or the like.

The storage 23 stores various types of information. The storage 23 stores various computer programs, various type of data, and the like to perform various types of processing in the processor 22. The storage 23 stores, for example, information regarding a background in the virtual space. The storage 23 stores a computer program for causing a computer of the server device 20 to execute a step of acquiring the primary information and the secondary information transmitted from each terminal device 10, setting the avatar information related to the image and the audio of each of the avatars of the users in the virtual space based on the secondary information to transmit the avatar information to each of the terminal devices 10, determining whether or not the avatars are in the intercommunication state based on the arrangement state of the avatars in the virtual space, and switching the avatar information of the avatars determined to be in the intercommunication state to the avatar information based on the primary information and transmitting the avatar information to each of the terminal devices 10 corresponding to each of the avatars determined to be in the intercommunication state.

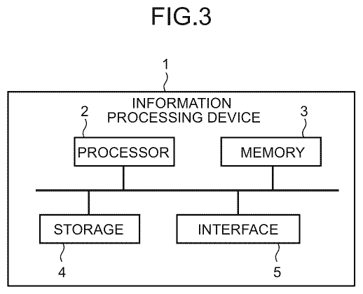

FIG. 3 is a functional block diagram illustrating an example of a hardware configuration of the information processing device according to the present embodiment. Each of the above-described terminal devices 10 (controller 16) and the server device 20 includes an information processing device 1. The information processing device 1 includes a processor 2, a memory 3, a storage 4, and an interface 5. The processor 2, the memory 3, the storage 4, and the interface 5 are connected to each other by a bus or the like.

The processor 2 includes, for example, arithmetic devices such as a central processor (CPU) and a graphics processor (GPU). The memory 3 includes, for example, a non-volatile memory such as a read only memory (ROM) and a volatile memory such as a random access memory (RAM). The storage 4 includes, for example, storage devices such as a hard disk drive (HDD) and a solid state drive (SSD). The storage 4 stores computer programs for implementing the functions of the terminal device 10 (controller 16) and the server device 20, which are described above. The interface 5 includes an input/output circuit such as a network interface card. The interface 5 communicates with an external device.

The processor 2 reads each computer program stored in the storage 4 to load the computer program into the memory 3, and executes processing corresponding to each of the above-described functions. By reading and executing the computer program in this manner, the information processing device 1 operates as a computer that executes various types of information processing.

Note that the computer program is not limited to being stored in the storage 4. For example, the computer program may be delivered to the information processing device 1 via the network. Furthermore, the computer program recorded on an external recording medium may be read and delivered to the information processing device 1. Furthermore, the computer program is not limited to being executed by the information processing device 1. For example, another information processing device other than the information processing device 1 may execute the computer program, or the information processing device 1 and another information processing device may collaboratively execute the computer program.

Next, the operation of the transmission system 100 configured as described above will be described. In a case where a user who wants to use the virtual space provided by the server device 20 accesses the server device 20 via the terminal device 10, the processor 22 of the server device 20 causes the communication unit 21 to transmit spatial display information related to the virtual space and audio output information to the terminal device 10.

In the terminal device 10, the communication unit 17 receives the spatial display information and the audio output information transmitted from the server device 20. The processor 18 acquires the received spatial display information and the audio output information, causes the display 14 to display the background of the virtual space based on the acquired spatial display information, and causes the audio output unit 15 to output the audio in the virtual space based on the audio output information.

In the terminal device 10, the imager 11 captures the image of the user's appearance, the audio input unit 12 captures the audio such as the user's voice, and the operation unit 13 receives the operation from the user. The imager 11 outputs the imaging information to the controller 16. The audio input unit 12 outputs the audio collecting information to the controller 16. The operation unit 13 outputs the operation signal to the controller 16.

The processor 18 acquires the imaging information, the audio collecting information, and the operation signal, and generates the primary information and the secondary information based on the acquired information and the signals. In this state, for example, in a case where an operation to set an avatar of the user in the virtual space is input using the operation unit 13, the processor 18 causes the communication unit 17 to transmit the generated primary information and the secondary information to the server device 20 in association with the time.

In the server device 20, the communication unit 21 receives the primary information and the secondary information transmitted from the terminal device 10. The processor 22 acquires the primary information and the secondary information transmitted from the terminal device 10. The processor 22 sets the avatar information based on the secondary information in an initial state. In other words, the avatar information is set only using the secondary information among the primary information and the secondary information associated with the time. The processor 22 transmits the set avatar information to the terminal device 10. In the initial state, in a case where the primary information and the secondary information are acquired from the multiple terminal devices 10, the processor 22 sets all pieces of the avatar information based on the secondary information and transmits all pieces of the set avatar information to all the terminal devices 10.

In each terminal device 10, the communication unit 17 receives the avatar information transmitted from the server device 20. Based on the received avatar information, the processor 18 causes the display 14 to display the image of the avatar and causes the audio output unit 15 to output the audio produced by the avatar. In the initial state, the image of the avatar based on the secondary information is displayed on the display 14, and the audio of the avatar based on the secondary information is output from the audio output unit 15. In a case where the multiple avatars of the users exist in the virtual space, in the initial state, all the avatars are displayed on the display 14 in a manner based on the secondary information, and the audio is output from the audio output unit 15.

A user may try to communicate with another avatar by operating the operation unit 13 to move the avatar in the virtual space, for example, by talking to another avatar. In the server device 20, the processor 22 determines whether or not the avatars in the virtual space are in the intercommunication state.

In this case, the processor 22 determines whether or not the avatars are in the intercommunication state based on the arrangement state of the avatars in the virtual space. For example, the avatar's position in the virtual space, the direction in which the avatar is facing in the virtual space, and the avatar's posture in the virtual space are examples of the arrangement state.

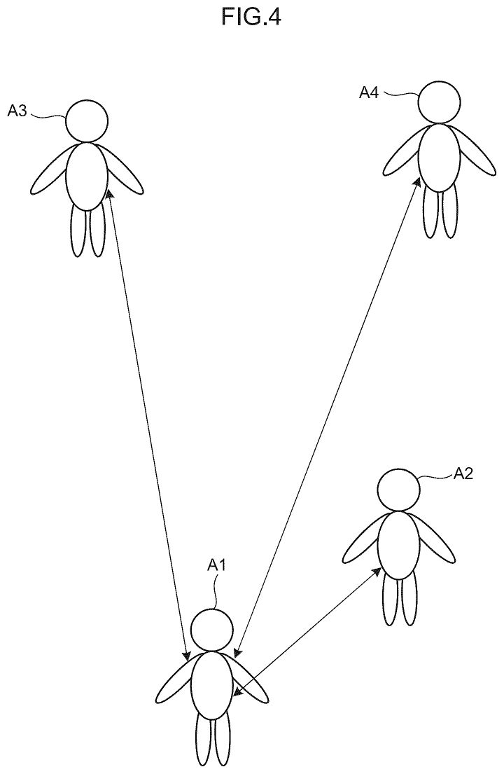

FIGS. 4 to 6 are diagrams illustrating examples of the arrangement state of the avatar in the virtual space. In FIGS. 4 to 6, the image of the background of the virtual space is omitted. As illustrated in FIG. 4, the processor 22 can determine whether or not the avatars are in the intercommunication state based on a distance between the avatars in the virtual space. For example, the processor 22 can determine that the avatars are in the intercommunication state in a case where the distance between the avatars is equal to or less than a predetermined value in the virtual space. In the example illustrated in FIG. 4, the processor 22 can determine that an avatar A1 and an avatar A2 are in the intercommunication state. Furthermore, it can be determined that an avatar A3 and an avatar A4 are not in the intercommunication with other avatars.

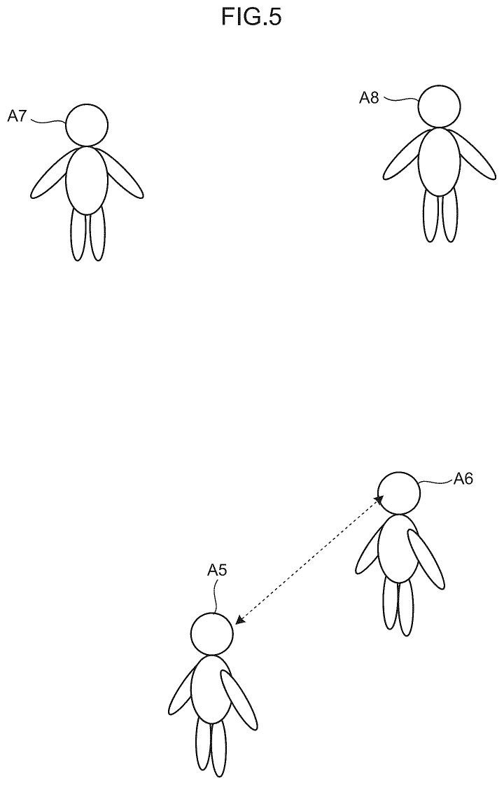

As illustrated in FIG. 5, the processor 22 can also determine whether or not the avatars are in the intercommunication state based on the avatars' orientation in the virtual space. For example, in a case where the avatars are facing each other in the virtual space, the processor 22 can determine that the avatars are in the intercommunication state. In the example illustrated in FIG. 5, the processor 22 can determine that an avatar A5 and an avatar A6 are in the intercommunication state. Furthermore, it can be determined that an avatar A7 and an avatar A8 are not in the intercommunication state with other avatars.

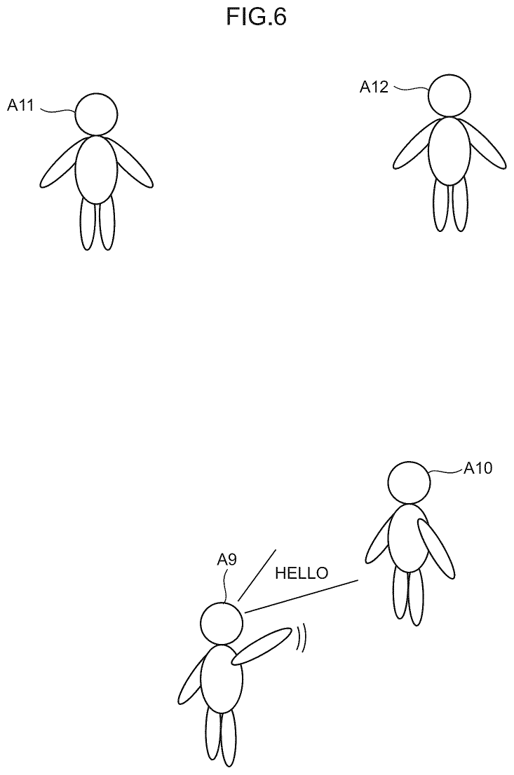

Furthermore, as illustrated in FIG. 6, the processor 22 can determine whether or not the avatars are in the intercommunication state based on the avatars' action in the virtual space. For example, in a case where one avatar talks to another avatar in the virtual space, the processor 22 can determine that the one avatar and the another avatar are in the intercommunication state. In the example illustrated in FIG. 6, the processor 22 can determine that an avatar A9 and an avatar A10 are in the intercommunication state. Furthermore, it can be determined that an avatar A11 and an avatar A12 are not in the intercommunication state with other avatars. Note that, in addition to this, the processor 22 can determine that one avatar and another avatar are in the intercommunication state, for example, in a case where one avatar performs a pointing action toward another avatar, touches or tries to touch another avatar with a hand, or handwaves to another avatar, or in a case where a user operating one avatar selects another avatar by using the operation unit 13.

The processor 22 may determine that the avatars are in the intercommunication state when two or more among the cases illustrated in FIGS. 4 to 6 (the distance between the avatars in the virtual space, the orientation, and the action) are satisfied. In this case, for example, the processor 22 may set a priority for conditions for determining the intercommunication state as follows: first, determining the distance between the avatars; then determining whether or not the avatars are facing each other in a case where the distance is less than a predetermined value; and then determining that the avatars are in the intercommunication state in a case where the avatars are facing each other.

The processor 22 switches the avatar information of the avatars determined to be in the intercommunication state to the setting based on the primary information and transmits the avatar information to the terminal devices 10 corresponding to the avatars determined to be in the intercommunication state. On the other hand, the processor 22 transmits, to the terminal device 10 corresponding to the avatar determined not to be in the intercommunication state, the avatar information of the avatars determined not to be in the intercommunication state with the setting based on the secondary information.

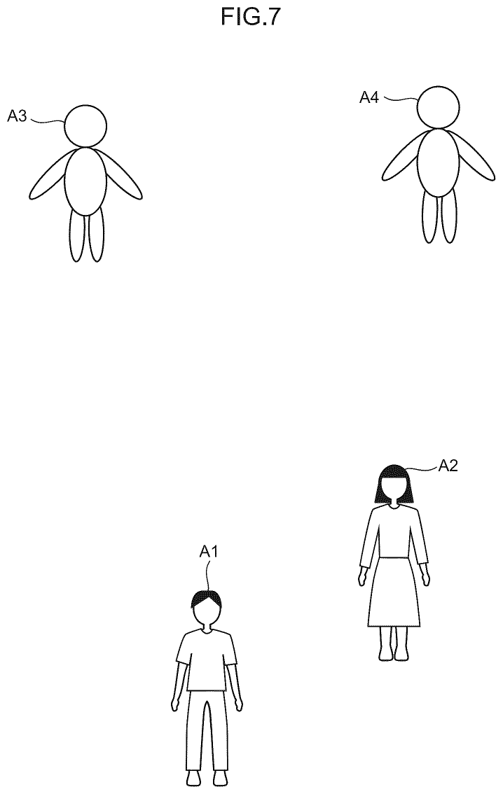

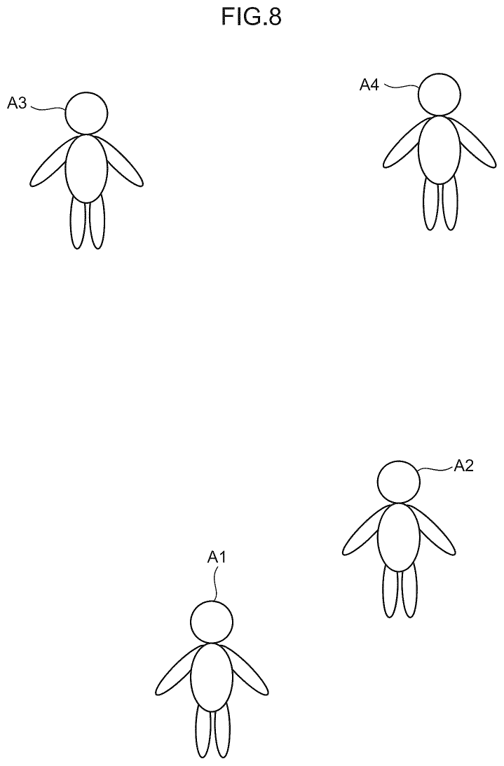

FIGS. 7 and 8 illustrate examples of information displayed on the display 14 of the terminal device 10. In FIGS. 7 and 8, the example corresponding to FIG. 4 is illustrated among the examples illustrated in FIGS. 4 to 6, but the same description can be provided in the examples corresponding to FIGS. 5 and 6. FIG. 7 illustrates a displayed example of the display 14 in the terminal device 10 of a user trying to perform communication in the virtual space. As illustrated in FIG. 7, in the terminal devices 10 corresponding to the avatars determined to be in the intercommunication state (the avatar A1 and the avatar A2 in the example in FIG. 4), the images of the avatars are displayed and the audio is output based on the avatar information that is set based on the primary information. In other words, the images and the audio of the avatars A1 and A2 are switched to the setting based on the primary information for the users who are trying to communicate with each other in the virtual space.

FIG. 8 illustrates a displayed example of the display 14 in the terminal device 10 of a user who does not perform communication in the virtual space. As illustrated in FIG. 8, in the terminal devices 10 corresponding to the avatars determined not to be in the intercommunication state (the avatar A3 and the avatar A4 in the example in FIG. 4), the images of the avatars are displayed and the audio is output based on the avatar information that is set based on the secondary information. In other words, the setting for the images and the audio of the avatars is not switched for the users who do not communicate with other users in the virtual space. In this manner, the avatars that are in the intercommunication state can be displayed as distinguished from other avatars to thereby implement the realistic display.

The processor 22 can determine the degree of the intercommunication state based on the arrangement state of the avatars that are determined to be in the intercommunication state. In this case, the processor 22 can set the reflection level of the primary information based on the degree of the intercommunication state.

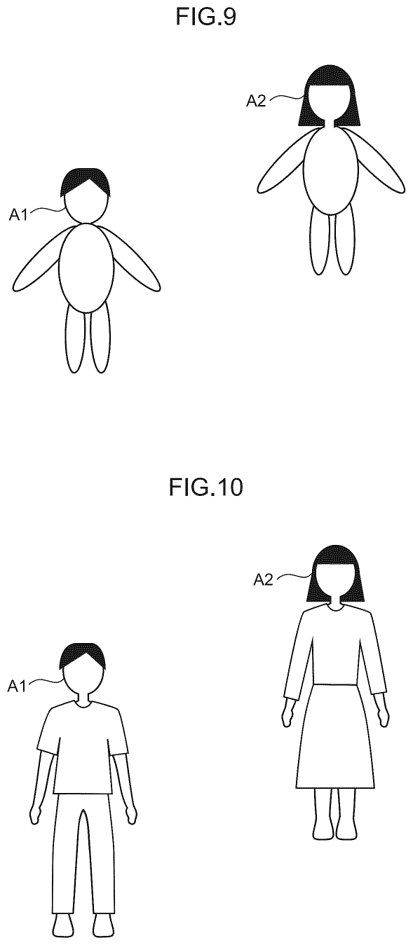

FIGS. 9 and 10 illustrate other examples of the information displayed on the display 14 of the terminal device 10. In FIGS. 9 and 10, the images of the background of the virtual space are omitted. In FIGS. 9 and 10, the example corresponding to FIG. 4 is illustrated among the examples illustrated in FIGS. 4 to 6, but the same description can be provided in the examples corresponding to FIGS. 5 and 6. The processor 22 can increase the reflection level of the primary information as the avatars get closer to each other. In this case, the processor 22 may increase, in a stepwise manner, the reflection level of the primary information is reflected for displaying the avatar's appearance, for example, by setting only an inner face portion of the avatar's appearance based on the primary information as illustrated in FIG. 9 in a case where the distance between the avatars is closer than a first threshold, and by setting the avatar's entire appearance based on the primary information as illustrated in FIG. 10 in a case where the distance between the avatars is closer than a second threshold smaller than the first threshold. Furthermore, the reflection level of the primary information may be increased in a stepwise manner for both the displayed appearance and the audio, for example, by further setting the audio of the avatar based on the primary information in addition to the state illustrated in FIG. 10.

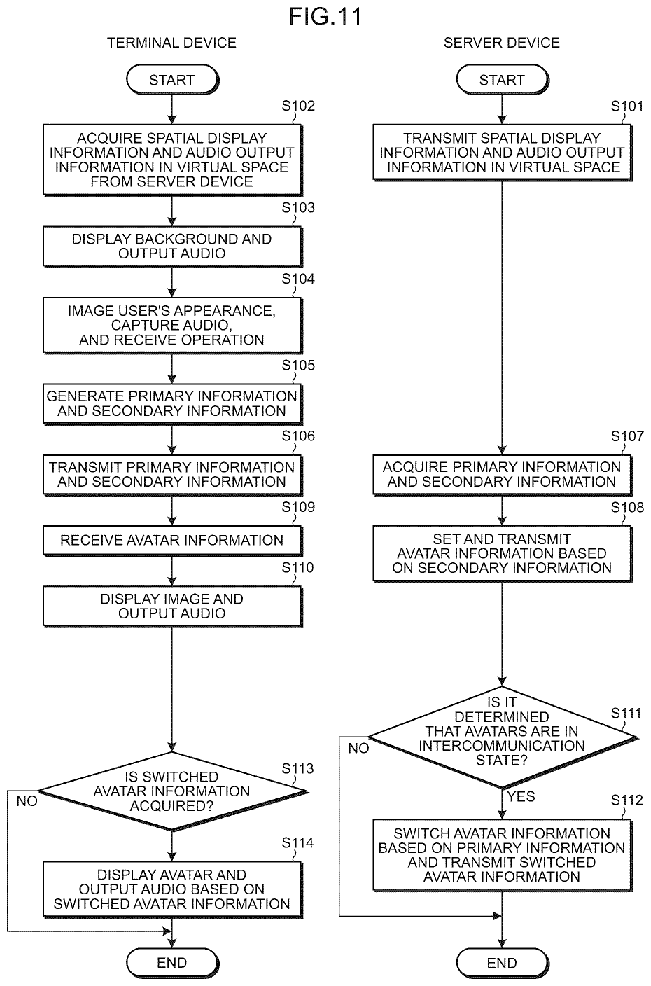

FIG. 11 is a flowchart illustrating an example of a processing flow in the transmission system 100 according to the present embodiment.

As illustrated in FIG. 11, in a case where the terminal device 10 accesses the server device 20 to use the virtual space, the processor 22 causes the communication unit 21 to transmit the spatial display information and the audio output information in the virtual space to the terminal device 10 (step S101). In the terminal device 10, the spatial display information and the audio output information transmitted from the server device 20 are received by the communication unit 17. The processor 18 acquires the received spatial display information and the audio output information (step S102). The processor 18 causes the display 14 to display the background of the virtual space, and the like based on the acquired spatial display information, and causes the audio output unit 15 to output the audio in the virtual space based on the audio output information (step S103).

In the terminal device 10, the imager 11 images the user's appearance, the audio input unit 12 captures audio such as the user's voice, and the operation unit 13 receives the operation from the user (step S104). The imager 11 outputs the imaging information to the controller 16. The audio input unit 12 outputs the audio collecting information to the controller 16. The operation unit 13 outputs the operation signal to the controller 16.

In the controller 16, the processor 18 acquires the imaging information, the audio collecting information, and the operation signal, and generates the primary information and the secondary information based on the acquired information and the signal (step S105). In response to the input from the operation unit 13, the processor 18 causes the communication unit 17 to transmit the generated primary information and the secondary information to the server device 20 in association with the time (step S106).

In the server device 20, the primary information and the secondary information transmitted from the terminal device 10 are received by the communication unit 21. The processor 22 acquires the primary information and the secondary information received by the communication unit 21 (step S107). The processor 22 sets the avatar information of each avatar corresponding to each of the terminal devices 10 in the initial state based on the secondary information, and transmits the set avatar information to each of the terminal devices 10 (step S108).

In each of the terminal devices 10, the avatar information transmitted from the server device 20 is received by the communication unit 17 (step S109). Based on the received avatar information, the processor 18 causes the display 14 to display the image of the avatar and causes the audio output unit 15 to output the audio produced by the avatar (step S110).

Thereafter, in the server device 20, the processor 22 determines whether or not the avatars are in the intercommunication state in the virtual space (step S111). In a case where it is determined that the avatars are in the intercommunication state (Yes at step S111), the processor 22 switches the avatar information of the avatars to the avatar information based on the primary information and transmits the switched avatar information to the terminal devices 10 corresponding to the avatars determined to be in the intercommunication state (step S112). In a case where it is determined that the avatars are not in the intercommunication state (No at step S111), the processor 22 skips the processing at step S112, in other words, maintains the avatar information.

In each terminal device 10, in a case where the switched avatar information is transmitted from the server device 20, the switched avatar information is received by the communication unit 17. In a case where the switched avatar information is acquired (Yes at step S113), the processor 18 causes the display 14 to display the images of the avatars and causes the audio output unit 15 to output the audio produced by the avatars based on the switched avatar information (step S114). In a case where the switched avatar information is not acquired (No at step S113), the processor 18 skips the processing at step S114, in other words, maintains the state of displaying the image of the avatar and outputting the audio.

As described above, a transmission system 100 according to the present embodiment includes: multiple terminal devices 10 each of which is configured to transmit primary information and secondary information in association with a time, the primary information including at least one of an image or audio of a user in a real space, the secondary information including at least one of an image or audio of the user in a virtual space; and a server device 20 configured to: acquire the primary information and the secondary information transmitted from each of the terminal devices 10; set avatar information regarding the image and the audio of each of avatars of the users in the virtual space based on the secondary information and transmit the avatar information to each of the terminal devices 10; determine whether or not the avatars are in an intercommunication state based on an arrangement state of the avatars in the virtual space; and switch the avatar information of the avatars determined to be in the intercommunication state to the avatar information based on the primary information and transmit the switched avatar information to the terminal devices 10 corresponding to the avatars determined to be in the intercommunication state.

Furthermore, a transmission method for a transmission system that comprises multiple terminal devices 10 and a server device 20 according to the present embodiment includes: transmitting, by each of the multiple terminal devices 10, primary information and secondary information in association with a time, the primary information including at least one of an image or audio of a user in a real space, the secondary information including at least one of an image or audio of the user in a virtual space; and acquiring, by the server device, the primary information and the secondary information transmitted from each of the terminal devices 10, setting avatar information regarding the image and the audio of each of avatars of the users in the virtual space based on the secondary information and transmitting the avatar information to each of the terminal devices 10, determining whether or not the avatars are in an intercommunication state based on an arrangement state of the avatars in the virtual space, and switching the avatar information of the avatars determined to be in the intercommunication state to the avatar information based on the primary information and transmitting the switched avatar information to the terminal devices 10 corresponding to the avatars determined to be in the intercommunication state.

Furthermore, in a non-transitory storage medium that stores a transmission program for a transmission system that comprises multiple terminal devices 10 and a server device 20 according to the present embodiment, the program causes a computer to execute: transmitting, by each of the multiple terminal devices 10, primary information and secondary information in association with a time, the primary information including at least one of an image or audio of a user in a real space, the secondary information including at least one of an image or audio of the user in a virtual space; and acquiring, by the server device, the primary information and the secondary information transmitted from each of the terminal devices 10, setting avatar information regarding the image and the audio of each of avatars of the users in the virtual space based on the secondary information and transmitting the avatar information to each of the terminal devices 10, determining whether or not the avatars are in an intercommunication state based on an arrangement state of the avatars in the virtual space, and switching the avatar information of the avatars determined to be in the intercommunication state to the avatar information based on the primary information and transmitting the switched avatar information to the terminal devices 10 corresponding to the avatars determined to be in the intercommunication state.

According to this configuration, the images and the audio of the avatars are switched to the images and the audio of the avatars based on the primary information for the users who are trying to communicate with each other in the virtual space. On the other hand, the images and the audio of the avatars are not switched for the users who do not communicate with other users in the virtual space. In this manner, the avatars that are in the intercommunication state can be set as distinguished from other avatars to thereby implement the realistic communication.

In the transmission system 100 according to the present embodiment, the server device 20 determines that the avatars are in the intercommunication state when the distance between the avatars in the virtual space is equal to or less than the predetermined value. According to this configuration, the intercommunication state between the avatars can be appropriately determined.

In the transmission system 100 according to the present embodiment, the server device 20 determines that the avatars facing each other in the virtual space are in the intercommunication state. According to this configuration, the intercommunication state between the avatars can be appropriately determined.

In the transmission system 100 according to the present embodiment, the server device 20 determines that one avatar and another avatar are in the intercommunication state in a case where one avatar talks to another avatar in the virtual space. According to this configuration, the intercommunication state between the avatars can be appropriately determined.

In the transmission system 100 according to the present embodiment, the server device 20 determines the degree of the intercommunication state based on the arrangement state of the avatars that are determined to be in the intercommunication state, and sets the reflection level of the primary information accordance with the degree of the intercommunication state. According to this configuration, the reflection level of the primary information varies in accordance with the degree of the intercommunication state, and thus more realistic communication can be implemented.

The technical range of the present application is not limited to the above embodiments, and within the scope not departing from the gist of the present application, various omission, replacement, and modifications of the components may be made.

The transmission system, the transmission method, and the non-transitory storage medium according to the present application can be used for the processing device such as the computer.

According to the present application, it is possible to provide the transmission system, the transmission method, and the non-transitory storage medium that are capable of implementing realistic communication in a virtual space.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A transmission system comprising:
multiple terminal devices each of which is configured to transmit primary information and secondary information in association with a time, the primary information including at least one of an image or audio of a user in a real space, the secondary information including at least one of an image or audio of the user in a virtual space; and
a server device configured to:
acquire the primary information and the secondary information transmitted from each of the terminal devices;
set avatar information regarding the image and the audio of each of avatars of the users in the virtual space based on the secondary information and transmit the avatar information to each of the terminal devices;
determine whether or not the avatars are in an intercommunication state based on an arrangement state of the avatars in the virtual space; and
switch the avatar information of the avatars determined to be in the intercommunication state to the avatar information based on the primary information and transmit the switched avatar information to the terminal devices corresponding to the avatars determined to be in the intercommunication state.

2. The transmission system according to claim 1, wherein the server device is further configured to determine that the avatars are in the intercommunication state when a distance between the avatars in the virtual space is equal to or less than a predetermined value.

3. The transmission system according to claim 1, wherein the server device is further configured to determine that the avatars facing each other in the virtual space are in the intercommunication state.

4. The transmission system according to claim 1, wherein the server device is further configured to determine that one avatar and another avatar are in the intercommunication state in a case where the one avatar talks to the another avatar in the virtual space.

5. The transmission system according to claim 1, wherein the server device is further configured to determine a degree of the intercommunication state based on the arrangement state of the avatars that are determined to be in the intercommunication state, and set a reflection level of the primary information in accordance with the degree of the intercommunication state.

6. A transmission method for a transmission system that comprises multiple terminal devices and a server device, the method comprising:
transmitting, by each of the multiple terminal devices, primary information and secondary information in association with a time, the primary information including at least one of an image or audio of a user in a real space, the secondary information including at least one of an image or audio of the user in a virtual space; and
acquiring, by the server device, the primary information and the secondary information transmitted from each of the terminal devices,
setting avatar information regarding the image and the audio of each of avatars of the users in the virtual space based on the secondary information and transmitting the avatar information to each of the terminal devices,
determining whether or not the avatars are in an intercommunication state based on an arrangement state of the avatars in the virtual space, and
switching the avatar information of the avatars determined to be in the intercommunication state to the avatar information based on the primary information and transmitting the switched avatar information to the terminal devices corresponding to the avatars determined to be in the intercommunication state.

7. A non-transitory storage medium that stores a transmission program for a transmission system that comprises multiple terminal devices and a server device, the program causing a computer to execute:
transmitting, by each of the multiple terminal devices, primary information and secondary information in association with a time, the primary information including at least one of an image or audio of a user in a real space, the secondary information including at least one of an image or audio of the user in a virtual space; and
acquiring, by the server device, the primary information and the secondary information transmitted from each of the terminal devices,
setting avatar information regarding the image and the audio of each of avatars of the users in the virtual space based on the secondary information and transmitting the avatar information to each of the terminal devices,
determining whether or not the avatars are in an intercommunication state based on an arrangement state of the avatars in the virtual space, and
switching the avatar information of the avatars determined to be in the intercommunication state to the avatar information based on the primary information and transmitting the switched avatar information to the terminal devices corresponding to the avatars determined to be in the intercommunication state.
